(19) United States
(12) Patent Application Publication
(10) Pub. No.: US 2015/0070657 A1
(43) Pub. Date: Mar. 12, 2015

(54) SYSTEM AND METHOD OF PRESENTING 3D IMAGES FOR A DISPLAY

(71) Applicant: Amir Said, Cupertino, CA (US)

(72) Inventor: Amir Said, Cupertino, CA (US)

(21) Appl. No.: 14/389,550

(22) PCT Filed: Apr. 30, 2012
(86) PCT No.: PCT/US2012/035770

§ 371 Date: Sep. 30, 2014

(51) Int. Cl. G02B 27/22

(52) U.S. Cl. CPC G02B 27/2214; G02B 3/0056
USPC 353/7; 353/121

(57) ABSTRACT

Disclosed is a three dimensional (3D) continuous display system based on a plurality of projexels. Each projexel may include of a plurality of light emitting devices. Each light emitting device may project a directional beam of light that spans an angular range. The sum of the angular ranges of each beam of light total an angular range for the projexel. Each projexel is also associated with a set of transition angles. The transition angles may be defined by the angle where two beams coincide. The projexels are configured such that sets of transition angles between adjacent projexels are offset.

### BACKGROUND

Current three-dimensional (3D) displays come in three types, those that require the use of polarized, colored or shuttered glasses, those that do not require glasses but provide only two views, and those that similar to holograms do not need glasses and provide many views, which are called glasses-free continuous three-dimensional (C3D) displays. This last type may be implemented using several technologies that define properties of 3D view quality and the type of visual artifacts that may be observed when viewers move in front of the display. One unavoidable artifact in all such displays is that parts of the 3D scene may appear disconnected and repeated (“ghosting”), or “jump” from one position to another as the viewer moves. A jump is an abrupt transition from one view to another. In some types of displays the changes can appear to occur relative to the whole display. In other types of displays different, but clearly visible, artifacts may appear at different positions within the display. Both cases can greatly degrade the perceived quality of the 3D image reproduction. Thus, it is desirable to eliminate visually discernible patterns making any ghosting or jump artifacts much less annoying.

### SUMMARY

Disclosed is a three dimensional (3D) continuous display system based on a plurality of projexels. Each projexel may include of a plurality of light emitting devices. Each light emitting device may project a directional beam of light that spans an angular range. The sum of the angular ranges of each beam of light total an angular range for the projexel. Each projexel is also associated with a set of transition angles. The transition angles may be defined by the angle where two beams coincide. The projexels are configured such that sets of transition angles between adjacent projexels are offset.

### BRIEF DESCRIPTION OF THE DRAWINGS

FIG. 1 illustrates one example of projexels having offset transition angles according to an embodiment.

FIG. 2 illustrates one example of a display emitting beams of lights from projexels having offset transition angles according to an embodiment.

FIG. 3 illustrates a perspective view of one example of a lens matrix covering a pixel display according to an embodiment.

FIG. 4 illustrates one example of a rectangular lens matrix covering a pixel display according to an embodiment.

FIG. 5 illustrates one example of a hexagonal lens matrix covering a pixel display according to an embodiment.

FIG. 6 illustrates another example of projexels having offset transition angles according to an embodiment.

FIG. 7 illustrates another example of a display emitting beams of lights from projexels having offset transition angles according to an embodiment.

FIG. 8 illustrates a perspective view of one example of a projection system for projexels according to an embodiment.

FIG. 9 illustrates a perspective view of another example of a projection system for projexels according to an embodiment.

FIG. 10 illustrates an embodiment of a logic flow in which a set of projexels may emit multiple beams at offset transition angles according to an embodiment.

### DETAILED DESCRIPTION

Glasses-free continuous three-dimensional (3D) displays may be implemented using several technologies that define properties of 3D view quality and the type of visual artifacts that may be observed when viewers move in front of the display. One unavoidable artifact in all such displays is that parts of the 3D scene may appear disconnected and repeated (“ghosting”), or “jump” from one position to another as the viewer moves. In some types of displays the changes can appear to occur relative to the whole display. In other types of displays different, but clearly visible, artifacts may appear at different positions within the display. Both cases can greatly degrade the perceived quality of the 3D image reproduction. Embodiments described herein exploit the fact that some types of display can be designed so that changes are randomly spread in a controlled manner. The randomness of any changes eliminates visually discernible patterns and reduces the perception and impact of viewable artifacts such as ghosting or jumping.

A fundamental concept used to describe the embodiments herein is a light-modulation element referred to as a projexel. A glass-free continuous 3D display (C3D) can be modeled as composed by a plurality of projexels. A projexel may be associated with multiple light emitting devices that modulate light in directional beams. Each projexel may modulate light differently according to propagation direction. Because each projexel does not necessarily behave as its neighboring projexel, an element of directional variation is introduced. This is in contrast to conventional pixels that have the same modulated light intensity in all directions.

There may be many different ways to implement C3D displays with elements that are functionally equivalent to projexels. For example, C3D displays may be built using arrays of projectors, combined with retro-reflective screens, or combined with special diffuser or reflective screens. Other types of C3D displays may use arrays of micro-lenses with spherical or cylindrical symmetry, or other optical technologies such as fiber optics or light emitting diodes (LEDs), lasers, or controlling directional light beams using sub-wavelength optics. A collection of lens arrays may comprise a matrix of lenses.

In the aforementioned C3D displays, distortions may be clearly visible when many beam transitions occur with respect to the same viewing position. In the case in which each projexel utilizes the same set of transition angles, artifacts occur on a few display positions simultaneously, and jump frequently as the viewer moves. In the case in which each projexel utilizes the same set of transition angles and the transition angles have been optimized for a specific viewing distance from the display, the jumps and blur may appear less frequently, but when they do these artifacts can appear in the whole display.

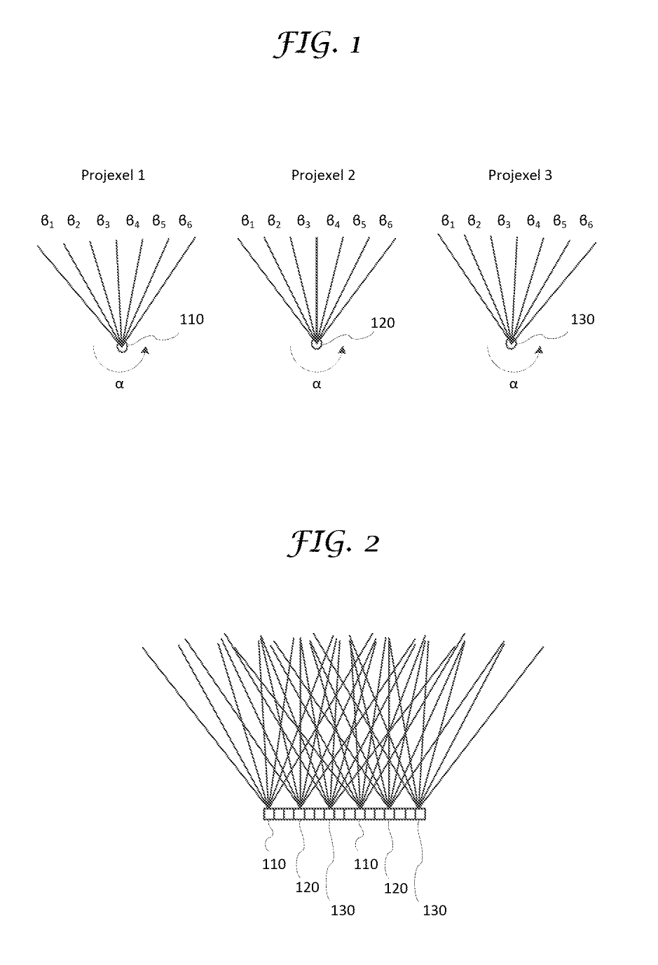

The premise is based on the idea that variable beam transitions will result in changes to the image that are not nearly as discernible by a viewer regardless of the viewing position. The variable beam transitions may cause artifacts to appear as distributed noise throughout the view which is far less annoying to the viewer on the whole. Using this technique, combinations of transitions appear to occur more randomly throughout the displayed image. The end result is that changes are not so significant as to annoyingly distract the viewer. The embodiments may achieve the goal by using sets of transitions angles corresponding to same angular range, but with pseudo-random offsets for each projexel as shown in FIG. 1.

Displays based on arrays of projectors do not offer much flexibility on the possible choices of projexel transition angles because those transitions are defined by the physical arrangement of projectors.

Direct view displays, like those using a matrix of micro-lenses or other type of small optical elements, are more amenable to variations on individual projexels. This can be done in several manners. For example, a display using a matrix of square micro-lenses that cover a conventional display can produce the same effect using a pixel pitch that is not an integer multiple of the projexel pitch, and the pixel matrix may be slightly slanted. Note that in this case the positions of transitions between pixels, which map directly to transitions between projexel beams may be slightly different in each projexel (lens).

Displays based on more advanced optics based on nano-scale elements allow even more flexibility because the light emitting devices themselves may be controllable or adjustable with respect to the direction in which beams of light are emitted. There are many possible choices for changing the sets of transition angles, ranging from the complete random offsets, to cases when small amounts of randomness are added to the more conventional schemes to create other types of 3D view changes that are both gradual and not easily perceived.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

FIG. 1 illustrates one example of projexels 110, 120, 130 having offset transition angles according to an embodiment. A projexel may be associated with multiple light emitting devices that modulate light at different angles. The visual distortions that can appear in a C3D display can be better understood considering that different projexels can create light beams with different sets of transition angles. Transition angles refer to the angles where light intensity from one beam transitions to another beam. The transition angles define the transitions of light beams in the vertical and horizontal directions for a display in a vertical plane. Each light beam, however, can have the shape of a pyramid in a 3D space. To simplify the explanation and figures, the examples have been described with respect to transitions in a single horizontal plane.

The projexels may be configured such that sets of transition angles between adjacent projexels are offset, with offset patterns chosen to optimize 3D view quality, and support special 3D display features. In the example of FIG. 1, projexel 110 has an overall angular range, α, that is equal to the sum of the angles for each of the beams, β₁-β₆, associated with projexel 110. Each individual beam begins and ends at a particular angular direction. For purposes of this illustration, 0° is considered a vertical line extending from the projexels 110, 120, 130. The angular range for each of the projexels 110, 120, 130 may be 60°. This is an arbitrary illustration not intended to limit the disclosure in any way.

Considering projexel 110, β₁ may span from −32° to −22°. β₂ may span from −22° to −12°. β₃ may span from −12° to −2°. β₄ may span from −2° to 8°. β₅ may span from 8° to 18°. β₆ may span from 18° to 28°. Each beam has its own angular range of 10° and there are five transition angles for projexel 110. The five transition angles comprise the set {−22°, −12°, −2°, 8°, 18°}. The embodiments are not limited to this example.

Considering projexel 120, β₁ may span from −30° to −20°. β₂ may span from −20° to −10°. β₃ may span from −10° to 0°. β₄ may span from 0° to 10°. β₅ may span from 10° to 20°. β₆ may span from 20° to 30°. Each beam has its own angular range of 10° and there are five transition angles for projexel 120. The five transition angles comprise the set {−20°, −10°, 0°, 10°, 20°}. The embodiments are not limited to this example.

Considering projexel 130, β₁ may span from −28° to −18°. β₂ may span from −18° to −8°. β₃ may span from −8° to 2°. β₄ may span from 2° to 12°. β₅ may span from 12° to 22°. β₆ may span from 22° to 32°. Each beam has its own angular range of 10° and there are five transition angles for projexel 130. The five transition angles comprise the set {−18°, −8°, 2°, 12°, 22°}. The embodiments are not limited to this example.

There is an offset of 2° for each of the sets of transition angles for the three projexels 110, 120, 130. The variation from projexel to projexel has the effect of spreading changes in a 3D image throughout the display in a less observable manner resulting in a viewing experience that significantly reduces annoying artifacts.

FIG. 2 illustrates one example of a display emitting beams of lights from projexels having offset transition angles according to an embodiment. In this example, the projexels 110, 120, 130 of FIG. 1 are presented as if they were emanating from a display screen. By placing them side by side as would be experienced in viewing a display, the variations of the beam transition angles prevent the beams from converging at points in the viewable area. Since there is no discernible convergence of the beams from projexels 110, 120, 130, the artifacts associated with the convergence points are eliminated or greatly reduced. It should be noted that three projexels 110, 120, 130 with 2° offset transition angles have been illustrated. This is exemplary only. For instance, a repeating pattern of more than three different projexels may be implemented to achieve an even greater noise smoothing effect. Moreover, the degree of the offset, 2° in this example, may be variable as would be known by those of ordinary skill in the art.

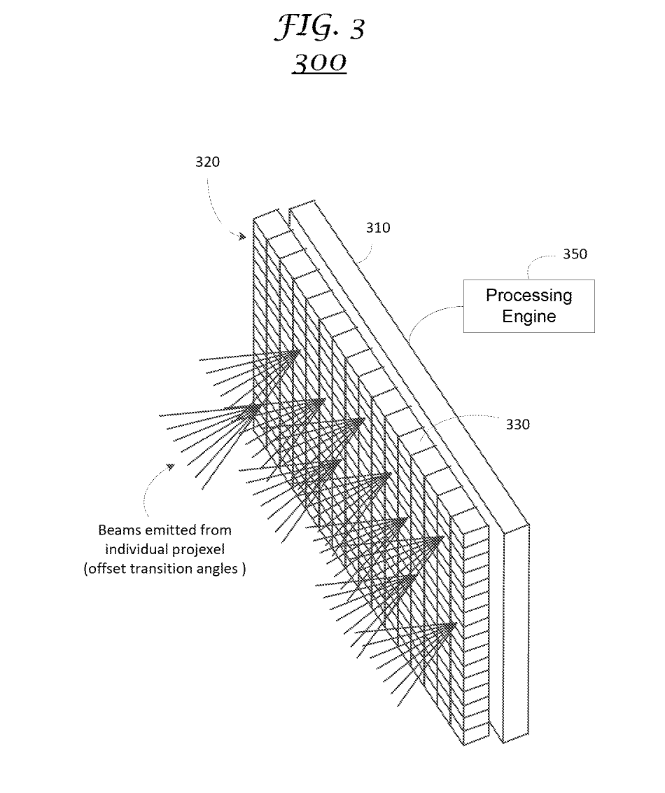

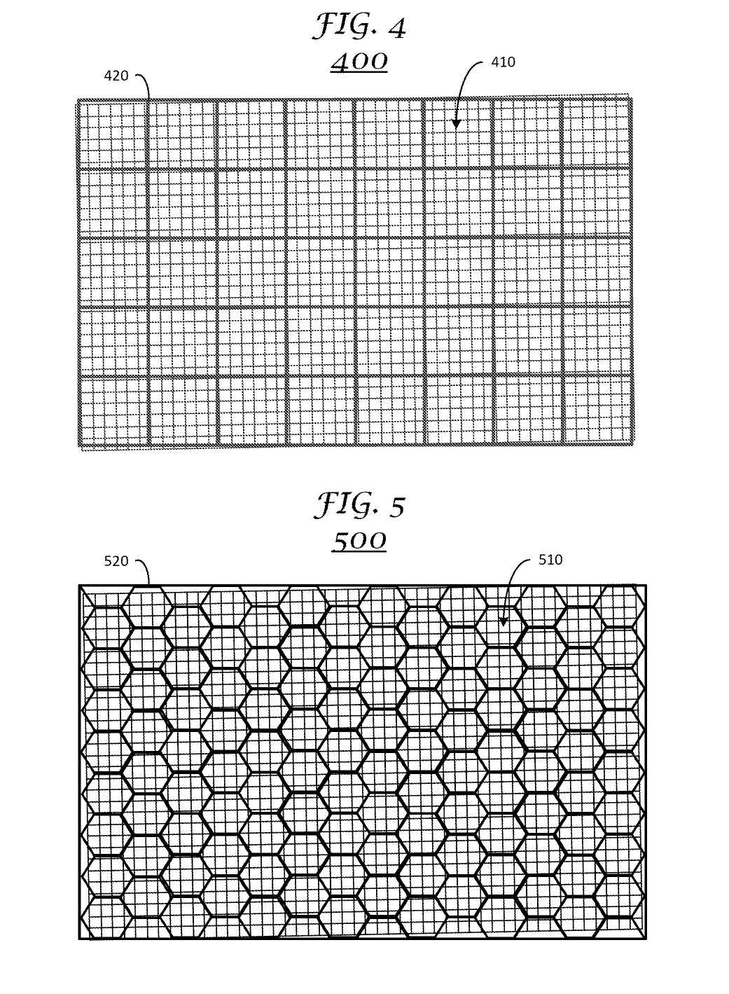

FIG. 3 illustrates a perspective view 300 of one example of a lens matrix 320 covering a pixel display 310 according to an embodiment. In this example, pixel display may be a conventional display 310 driven by a processing engine 350. By conventional it is meant that the display 310 may be comprised of a matrix of pixels, each pixel emitting light uniformly in all directions. The lens matrix 320 may be comprised of a collection of lenses 330 in which each lens 330 acts as a projexel. Thus, each lens 330 of the lens matrix 320 encompasses its own sub-matrix of pixels. A sampling of beams of light emitted from various projexels (lenses) is also shown. For reasons described above and further described in FIGS. 4-5, the transition angles of the beams vary from projexel to projexel (e.g., lens to lens) creating beams emanating from display 310 through the lens matrix 320 that do not necessarily converge in or at specified points or distances from the display 310.

FIG. 4 illustrates one example 400 of a rectangular lens matrix 420 covering a pixel display 410 in which the lens matrix 420 and pixel display 410 are offset or slightly askew with one another according to an embodiment. The lens matrix 420 still covers the pixel display 410 but the non-regular alignment between the display 410 and the lens matrix 420 may create a pattern in which projexels (e.g., the individual lenses of the lens matrix) emit beams of light that have different sets of transition angles from projexel to projexel. This results from a geometry in which the pixel pitch of the display 410 is not an integer multiple of the projexel pitch of the lens matrix 420. The embodiments are not limited to this example.

FIG. 5 illustrates one example 500 of a hexagonal lens matrix 520 covering a pixel display 510 in which the lens matrix 520 and pixel display 510 are offset or slightly askew with one another according to an embodiment. The lens matrix 520 still covers the pixel display 510 but the non-regular alignment between the display 510 and the lens matrix 520 may create a pattern in which projexels (e.g., the individual lenses of the lens matrix) emit beams of light that have different sets of transition angles from projexel to projexel. This results from a geometry in which the pixel pitch of the display 510 is not an integer multiple of the projexel pitch of the lens matrix 520. The embodiments are not limited to this example. For instance, other polygonal shaped lenses may be implemented as well.

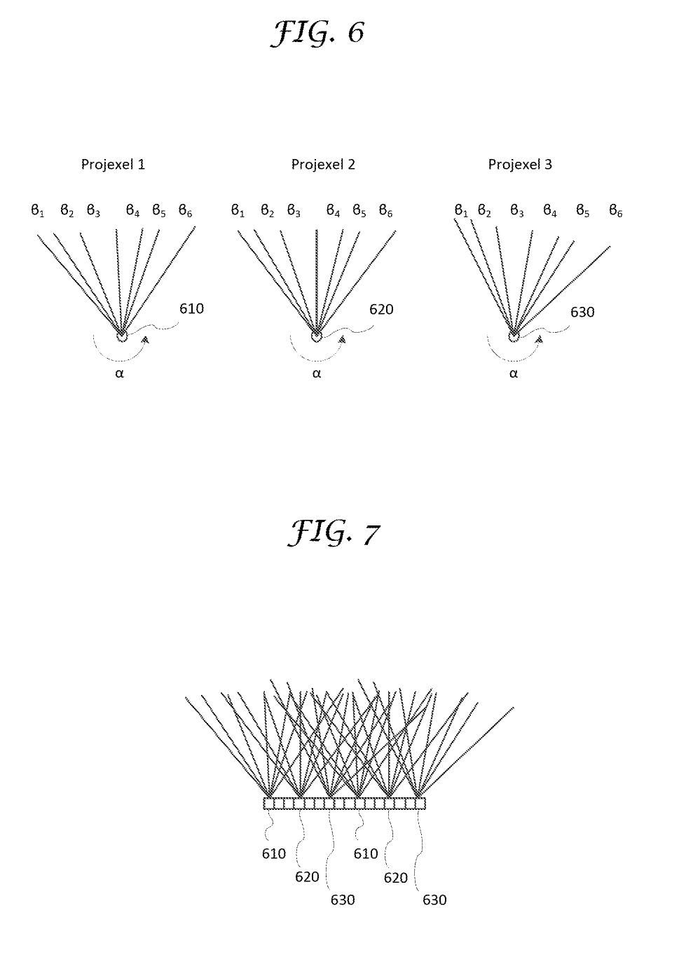

FIG. 6 illustrates another example of projexels 610, 620, 630 having offset transition angles according to an embodiment. Just as described in FIG. 1, a projexel may be associated with multiple light emitting devices that modulate light at different angles. The visual distortions that can appear in a C3D display can be better understood considering that different projexels can create light beams with different sets of transition angles. Transition angles refer to the angles where light intensity from one beam transitions to another beam. In this example, projexel 610 has an overall angular range, α, that is equal to the sum of the angles for each of the beams, β₁-β₆, associated with projexel 110. Each individual beam begins and ends at a particular angular direction. For purposes of this illustration, 0° is considered a vertical line extending from the projexels 610, 620, 630. The angular range for each of the projexels 610, 620, 630 may be 60°. This is an arbitrary illustration not intended to limit the disclosure in any way.

If the light emitting devices that a projexel encompasses are individually configurable, then each light emitting device may be configured to emit a beam of light according to its own angular range and projection direction. The sum of the individual angular ranges of the beams may still be the same from projexel to projexel but each individual angular range may be different. To ensure there are no dark spots, the beams may still be configured to continuously span the overall angular range. That is, there do not have to be gaps between adjacent beams, and the beams may overlap. This is different than using a lens matrix to cover a uniform pixel matrix. Recall that a pixel emits light of uniform intensity in all directions and the lenses illustrated in FIGS. 1-5 serve to manipulate each pixel uniformly. The embodiment now described differs in that light emitting devices are not comprised of a matrix of pixels but may be individually configurable devices. Some examples of configurable light emitting devices may include, but are not limited to, optical fibers and light emitting diodes (LEDs) or lasers. The additional degree of freedom allowed by these devices facilitates the creation of display features that may be achieved by varying the density of light beams along certain viewing directions.

Considering projexel 610, β₁ may span from −32° to −26° for an individual angular range of 6°. β₂ may span from −26° to −17° for an individual angular range of 9°. β₃ may span from −17° to −2° for an individual angular range of 15°. β₄ may span from −2° to 8° for an individual angular range of 10°. β₅ may span from 8° to 15° for an individual angular range of 7°. β₆ may span from 15° to 28° for an individual angular range of 13°. Thus, in this example, each beam has a different angular range (β₁-β₆) relative to the other beams. There are still five transition angles for projexel 610. The five transition angles of this example comprise the set {−26°, −17°, −2°, 8°, 15°}. The embodiments are not limited to this example.

Considering projexel 620, β₁ may span from −30° to −24° for an individual angular range of 6°. β₂ may span from −24° to −15° for an individual angular range of 9°. β₃ may span from −15° to 0° for an individual angular range of 15°. β₄ may span from 0° to 10° for an individual angular range of 10°. β₅ may span from 10° to 17° for an individual angular range of 7°. β₆ may span from 17° to 30° for an individual angular range of 13°. Thus, in this example, each beam has a different angular range (β₁-β₆) relative to the other beams. There are still five transition angles for projexel 610. The five transition angles of this example comprise the set {−24°, −15°, 0°, 10°, 17°}. The embodiments are not limited to this example.

Considering projexel 630, β₁ may span from −28° to −22° for an individual angular range of 6°. β₂ may span from −22° to −13° for an individual angular range of 9°. β₃ may span from −13° to 2° for an individual angular range of 15°. β₄ may span from 2° to 12° for an individual angular range of 10°. β₅ may span from 12° to 19° for an individual angular range of 7°. β₆ may span from 19° to 32° for an individual angular range of 13°. Thus, in this example, each beam has a different angular range (β₁-β₆) relative to the other beams. There are still five transition angles for projexel 610. The five transition angles of this example comprise the set {−22°, −13°, 2°, 12°, 19°}. The embodiments are not limited to this example.

In addition to the variations among the individual beams that comprise a projexel, there is an offset of 2° for each of the sets of transition angles for the three projexels 610, 620, 630. The variation from projexel to projexel has the effect of spreading changes in a 3D image throughout the display in a less observable manner resulting in a viewing experience that significantly reduces annoying artifacts. It should be noted, however, that varying the individual beams does not necessarily need to be incorporated into embodiments that have the ability to configure the light emitting devices individually. Individual beams having equivalent angular ranges will still provide the benefits described above with reference to FIGS. 1-5. Varying individual beams may, however, add another layer of pseudo-randomness or variability to the overall display to further spread noise artifacts throughout the entire display area resulting in a more pleasant viewing experience. The embodiments are not limited to this example.

FIG. 7 illustrates another example of a display emitting beams of lights from projexels having offset transition angles according to an embodiment. In this example, the projexels 610, 620, 630 of FIG. 6 are presented as if they were emanating from a display screen. By placing them side by side as would be experienced in viewing a display, the variations of the beam transition angles prevent the beams from converging at points in the viewable area. Because there is no discernible convergence of the beams from projexels 610, 620, 630, the artifacts associated with the convergence points are eliminated or greatly reduced. Moreover, the individual variation of beam projection angles in combination with the offset transition angles from projexel to projexel further enhance the viewing experience by further reducing areas of convergence of beams.

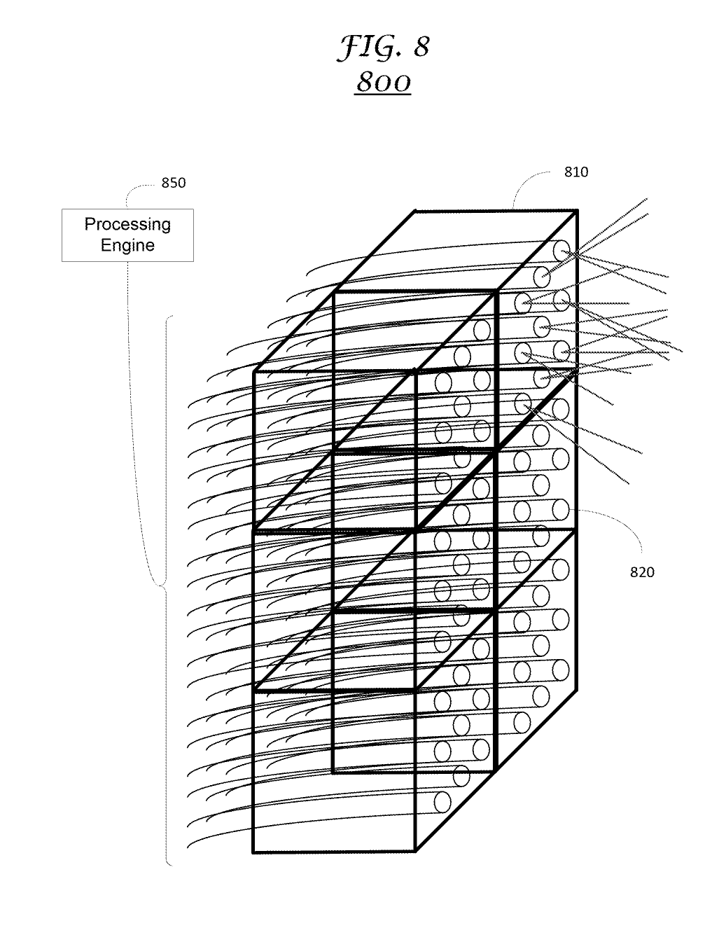

FIG. 8 illustrates a perspective view of one example of a projection system for projexels according to an embodiment. In this example, display 800 may be comprised of a matrix of individually configurable light emitting devices 820 driven by a processing engine 850. Each light emitting device 820 may emit light in a configurable direction at an angular range that may be determined by the size of the light emitting device 820. For instance, in this example the light emitting devices 820 may be optical fibers. Each of the optical fibers may be configured to project a beam of light in a particular direction. Moreover, the size of the optical fiber may determine how much of an angular range an emitted beam of light may have. The concept of the projexel may be satisfied here by logically partitioning a plurality of light emitting devices 820 into a groups represented by boxes to be referred to as projexels 810. Each projexel 810 encompasses a plurality of light emitting devices 820 in which the individual light emitting devices 820 are configured to cover, as a whole, an angular range wherein each individual light emitting device 820 is responsible for a portion of the overall angular range of the projexel 810. As described above with reference to FIGS. 6-7, each projexel may have a set of transition angles that is offset from its neighboring projexel's set of transition angles. The transition angle offset between adjacent pixels adds a variability to the display screen that reduces the convergence of light beams and therefore disperses noise artifacts throughout the display from any given viewpoint. This, in turn, creates an overall smoother picture representation devoid of annoying jumps and ghosting artifacts.

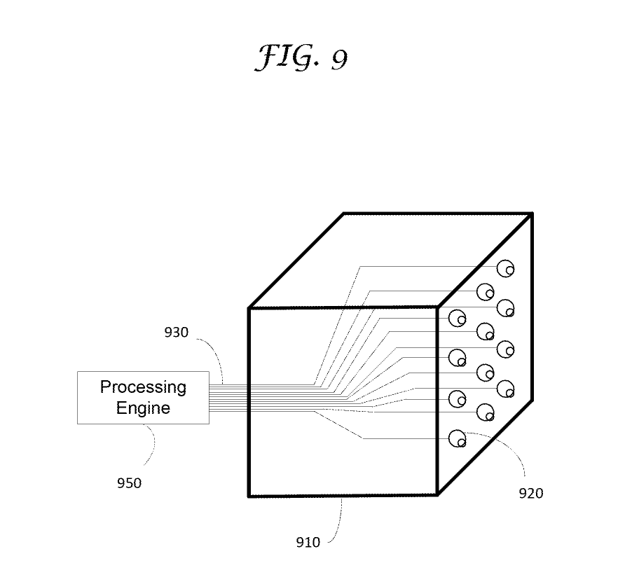

FIG. 9 illustrates a perspective view of another example of a projection system for projexels according to an embodiment. This example is similar to that of FIG. 8 but with an alternative to using optical fibers as the light emitting devices. In this example, a projexel 910 may encompass a matrix of individually configurable light emitting diode (LEDs) 920 coupled via wiring 930 to a processing engine 950. Each LED 920 may emit light in a configurable direction at an angular range that may be determined by the size of the LED 920. Each LED 920 may be configured to project a beam of light in a particular direction. Each projexel 910 may be configured to cover, as a whole, an angular range wherein each individual LED 920 is responsible for a portion of the overall angular range of the projexel 910. As described above with reference to FIGS. 6-7, each projexel may have a set of transition angles that is offset from its neighboring projexel's set of transition angles. The transition angle offset between adjacent pixels adds a variability to the display screen that reduces the convergence of light beams and therefore disperses noise artifacts throughout the display from any given viewpoint. This, in turn, creates an overall smoother picture representation devoid of annoying jumps and ghosting artifacts.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation

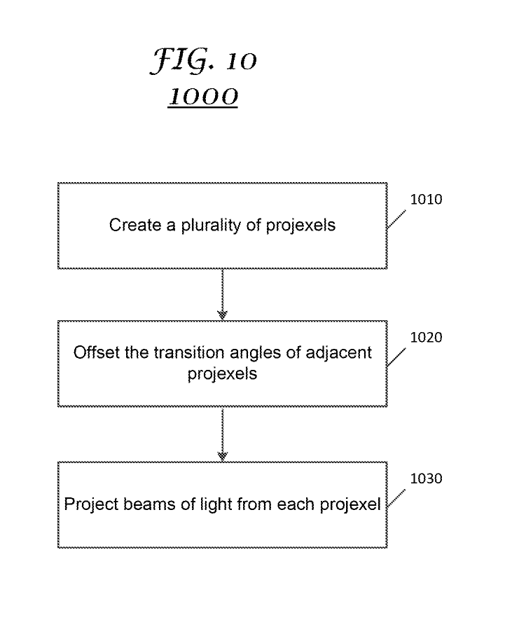

FIG. 10 illustrates an embodiment of a logic flow 1000 in which a set of projexels may emit multiple beams of light for a display. Each projexel may be characterized by a set of transition angles that correspond to the angles where adjacent beams of light are co-incidental. Adjacent projexels may be characterized by offset transition angles according to an embodiment such that when all the beams from all the projexels are projected from the display, an element of pseudo-randomness or variability is introduced that reduces the annoying effect of visual artifacts such as ghosting or abrupt jumps in the scene. The logic flow 1000 may be representative of some or all of the operations executed by one or more embodiments described herein.

In the illustrated embodiment shown in FIG. 10, may create a plurality of projexels at block 1010. For instance, a projexel may be thought of as a logical unit that encompasses a plurality of light emitting devices. The light emitting devices may include a matrix of pixels, a matrix of optical fibers, or a matrix of LEDs. If the light emitting devices are comprised of a matrix of pixels, a lens matrix covering the pixel matrix may be used to create the projexels. Each lens of the lens matrix may encompass a sub-matrix of pixels resulting in each lens corresponding to a projexel. If the light emitting devices are optical fibers or LEDs, then a projexel may be a logical grouping of such devices. No special lens matrix is required provided the optical fibers and LEDs are individually configurable as it pertains to directionality of the light beams each projects. Each projexel may be characterized by a set of transition angles that correspond to the angles where adjacent beams of light are co-incidental. The embodiments are not limited to this example.

In the illustrated embodiment shown in FIG. 10, may offset the transition angles of adjacent projexels at block 1020. For instance, each projexel includes its own set of transition angles as described above. Offsetting the transition angles between neighboring projexels introduces a pseudo-random or variable beam pattern in which there are fewer or even no beam convergence points in the space in front of the display. To offset adjacent projexels using a lens matrix covering a pixel matrix, the lens matrix may be set askew in the x and y directions to ensure that the pixel pitch is not an integer multiple of the projexel pitch. To offset adjacent projexels using optical fibers or LEDs, the optical fibers or LEDS may be configured directionally within the display negating the need for a lens matrix. The embodiments are not limited to this example.

In the illustrated embodiment shown in FIG. 10, may project beams of light from each projexel at block 1030. For instance, the processing engine may send signals to drive the light emitting devices to project light. If the light emitting devices are a pixel matrix, the lens matrix will re-form the uniform omni-directional light emission into specific beams of light according to the geometry of the individual lenses and the lens matrix as a whole. If the light emitting devices are optical fibers, each one may project a beam of light in the direction in which it is configured. Similarly, if the light emitting devices are LEDs, each one may project a beam of light in the direction in which it is configured. The embodiments are not limited to this example.

Because the projexels cause the beams of light to be projected in a pseudo-random, non-uniform manner, there will not be any convergence points in which a beam from each projexel intersects. This pseudo-random beam scattering as illustrated in FIGS. 2 and 7 results in a significant reduction in annoying noise artifacts such as ghosting or abrupt jumps in a scene as a viewer moves about space in front of a display.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A method of projecting a three dimensional (3D) image comprising:
creating a plurality of projexels comprising multiple beams of light, each projexel spanning an angular range, the angular range equivalent for each projexel;
directionally projecting the multiple beams of light from each projexel, each beam spanning an angular range, the sum of the beam angular ranges totaling the angular range for the projexel, each projexel having a set of transition angles, the transition angles defined by the angle where two beams coincide; and
offsetting the sets of transition angles between adjacent projexels.

2. The method of claim 1, the creating a plurality of projexels comprising covering a conventional display comprised of a matrix of pixels with a matrix of lenses to create the projexels and the projexel beams, each lens of the matrix of lenses associated with a plurality pixels of the matrix of pixels.

3. The method of claim 2, comprising offsetting the matrix of lenses in the x and y direction with respect to the matrix of pixels.

4. The method of claim 3, wherein the lenses within the matrix of lenses are rectangular.

5. The method of claim 3, wherein the lenses within the matrix of lenses are hexagonal.

6. The method of claim 1, the plurality of projexels comprising multiple light emitting devices that each emit a beam of light.

7. The method of claim 6, the light emitting devices comprising optical fibers.

8. The method of claim 6, the light emitting devices comprising light emitting diodes (LEDs).

9. A three dimensional (3D) projection apparatus comprising:
a matrix of lenses to substantially cover a matrix of pixels, the matrix of lenses offset in the x and y direction with respect to the matrix of pixels, each lens of the matrix of lens associated with a plurality pixels of the matrix of pixels,
wherein
each lens projects multiple beams of light that span an angular range, each beam spanning a fixed angular range, the sum of the fixed angular ranges of each beam totaling the angular range for the lens, each lens creating a set of transition angles between each beam of light; and
adjacent lens projections are directionally offset from one another as a result of x and y offset between the matrix of lenses and the matrix of pixels creating offset sets of transition angles from lens to lens within the matrix of lenses.

10. The apparatus of claim 9, wherein the lenses within the matrix of lenses are rectangular.

11. The apparatus of claim 9, wherein the lenses within the matrix of lenses are hexagonal.

12. A three dimensional (3D) continuous display system comprising:
a plurality of projexels, each projexel comprised of a plurality of light emitting devices, each light emitting device to project a directional beam of light that spans an angular range, the sum of the angular ranges of each beam of light totaling an angular range for the projexel, each projexel having a set of transition angles, the transition angles defined by the angle where two beams coincide, the sets of transition angles between adjacent projexels being offset.

13. The three dimensional (3D) continuous display system of claim 12, the light emitting devices within a projexel to project directional beams of light that span angular ranges that are not uniform.

14. The three dimensional (3D) continuous display system of claim 12, the light emitting devices within a projexel to project directional beams of light that span angular ranges that are uniform.

15. The three dimensional (3D) continuous display system of claim 12, the light emitting devices comprising optical fibers.

16. The three dimensional (3D) continuous display system of claim 12, the light emitting devices comprising light emitting diodes (LEDs).
